(19) United States
(12) Patent Application Publication
(10) Pub. No.: US 2025/0096481 A1
(43) Pub. Date: Mar. 20, 2025

(54) TRANSMISSION DEVICE AND ANTENNA

(71) Applicant: NIHON DENGYO KOSAKU CO., LTD., Tokyo (JP)

(72) Inventor: Uichiro AZUMA, CHIYODA-KU, Tokyo (JP)

(73) Assignee: NIHON DENGYO KOSAKU CO., LTD., Tokyo (JP)

(21) Appl. No.: 18/572,799

(22) PCT Filed: Sep. 29, 2022
(86) PCT No.: PCT/JP2022/036461

§ 371 Date: Dec. 21, 2023

(51) Int. Cl. H01Q 21/00; H01Q 13/20; H01R 12/57

(52) U.S. Cl. CPC H01Q 21/0075; H01Q 13/206; H01R 12/57

(57) ABSTRACT

A transmission device including: a transmission substrate for transmitting a signal, the transmission substrate including a feeding line and a capacitive coupling conductor that are provided on one side of a plate-shaped dielectric substrate and a ground conductor that is provided on other side of the dielectric substrate; and a connector for inputting and outputting a signal, the connector including an inner conductor and an outer conductor that is provided outside of the inner conductor, wherein the connector is provided on the one side of the dielectric substrate on which the feeding line and the capacitive coupling conductor of the transmission substrate are provided, and the inner conductor of the connector is connected to the feeding line, the outer conductor is connected to the capacitive coupling conductor, and the ground conductor of the transmission substrate is not connected to the outer conductor of the connector.

### TECHNICAL FIELD

The present disclosure relates to a transmission device and an antenna.

### BACKGROUND ART

Patent document 1 describes a connection structure of a microstrip line which includes a center conductor with a predetermined width arranged on one side of a substrate and a ground conductor arranged on the other side of the substrate, wherein an earth pattern connected to the ground conductor is formed on a conductor arrangement surface where the center conductor of the substrate is arranged, a connector with a connector inner conductor and a connector outer conductor is installed to the conductor arrangement surface, the connector inner conductor is connected to the center conductor of the microstrip line, and the connector outer conductor is connected to the earth pattern.

### CITATION LIST

### Patent Literature

[Patent Document 1] Microfilm of Japanese Utility Model Application No. H01-140181 (Japanese Unexamined Utility Model Application Publication No. H03-079510)

### SUMMARY OF INVENTION

### Technical Problem

By the way, in a microstrip antenna or the like, a transmission device which includes a feeding line on one side of a dielectric substrate and a transmission substrate (a so-called printed circuit board) and a connector on the other side of the dielectric substrate is used. Here, a radiating element that transmits and receives radio waves is connected to the feeding line, a ground conductor is provided to the transmission substrate, and the connector is connected with a coaxial cable and serves as a signal input/output: terminal. Connectors with a small outer dimension such as SMPM (Sub Miniature Push-on Mini) are mounted on a side of the transmission substrate where the feeding line is provided. For this reason, an outer conductor of the connector and the ground conductor of the transmission substrate have been connected via a through-hole or the like in the dielectric substrate whose inside is covered with a conductor. However, the provision of the through-hole or the like increases the manufacturing cost of the transmission device. Therefore, it is required not to provide the through-hole or the like that connects the outer conductor of the connector with the ground conductor of the transmission substrate.

The present invention provides a transmission device or the like that can operate without connecting the ground conductor of the transmission substrate with the outer conductor of the connector.

### Solution to Problem

The invention recited in claim 1 is a transmission device including: a transmission substrate for transmitting a signal, the transmission substrate including a feeding line and a capacitive coupling conductor that are provided on one side of a plate-shaped dielectric substrate and a ground conductor that is provided on other side of the dielectric substrate; and a connector for inputting and outputting a signal, the connector including an inner conductor and an outer conductor that is provided outside of the inner conductor, wherein the connector is provided on the one side of the dielectric substrate on which the feeding line and the capacitive coupling conductor of the transmission substrate are provided, and the inner conductor of the connector is connected to the feeding line, the outer conductor is connected to the capacitive coupling conductor, and the ground conductor of the transmission substrate is not connected to the outer conductor of the connector.

The invention recited in claim 2 is the transmission device according to claim 1, wherein, in the transmission substrate, the capacitive coupling conductor and the ground conductor face each other via the dielectric substrate.

The invention recited in claim 3 is the transmission device according to claim 2, wherein the ground conductor of the transmission substrate and the outer conductor of the connector are capacitively coupled.

The invention recited in claim 4 is the transmission device according to any one of claims 1 to 3, wherein, in the capacitive coupling conductor, an opening is formed at a center portion and a gap is formed from an outer edge to the opening, and an end of the feeding line is located at the gap.

The invention recited in claim 5 is the transmission device according to any one of claims 1 to 4, wherein a shape surrounding the outer edge of the capacitive coupling conductor is any one of polygonal, circular and oval.

The invention recited in claim 6 is the transmission device according to any one of claims 1 to 5, wherein a dimension from a center of the connector to an outer edge of the capacitive coupling conductor is more than ¼ and less than ½ of an effective wavelength in the dielectric substrate.

The invention recited in claim 7 is the transmission device according to any one of claims 1 to 5, wherein, among a dimension from a center of the connector to an outer edge of the capacitive coupling conductor, the transmission device transmits a signal with a lower limit of a frequency at which a minimum dimension corresponds to ¼ of an effective wavelength and with an upper limit of a frequency at which a maximum dimension corresponds to ½ of the effective wavelength.

The invention recited in claim 8 is an antenna including: a radiating element transmitting and receiving radio waves; and a transmission device according to any one of claims 1 to 7 which the radiating element is connected to and transmits a signal based on the radio waves transmitted and received by the radiating element.

The invention recited in claim 9 is the antenna according to claim 8, wherein, among a dimension from a center of the connector to an outer edge of the capacitive coupling conductor, the radiating element transmits and receives radio waves with a lower limit of a frequency at which a minimum dimension corresponds to ¼ of an effective wavelength and with an upper limit of a frequency at which a maximum dimension corresponds to ½ of the effective wavelength.

### Effect of the Invention

According to the invention recited in claims 1 and 8, the transmission device or the antenna can operate without connecting the ground conductor of the transmission substrate with the outer conductor of the connector.

According to the invention recited in claim 2, compared to the case of not facing each other, coupling capacitance can be increased.

According to the invention recited in claim 3, a DC connection is not required.

According to the invention recited in claim 4, the transmission device can be composed of a single conductor layer.

According to the invention recited in claim 5, the transmission device can have a shape according to the purpose.

According to the invention recited in claim 6, a shape of the capacitive coupling conductor can be set based on the effective wavelength.

According to the invention recited in claims 7 and 9, a shape of the capacitive coupling conductor can be set based on a frequency band.

### BRIEF DESCRIPTION OF DRAWINGS

FIGS. 1A and 1B illustrate a microstrip antenna in a millimeter wave band. FIG. 1A illustrates a microstrip antenna using a connector with a small outer dimension, and FIG. 1B illustrates a microstrip antenna using a connector with a large outer dimension.

FIGS. 2A to 2C illustrate a transmission device to which the first exemplary embodiment is applied. FIG. 2A is a perspective view in a state where a transmission substrate and a connector are in close proximity, FIG. 2B is a perspective view of the connector, and FIG. 2C is a perspective view in a state where the connector is mounted on the transmission substrate.

FIGS. 3A to 3C illustrate the transmission device to which the first exemplary embodiment is applied. FIG. 3A is a plan view, FIG. 3B is a side view, and FIG. 3C shows parameters of Example 1 used in a simulation.

FIGS. 4A and 4B show S-parameters of Example 1 and the comparative example obtained by the simulation. FIG. 4A shows S11 and FIG. 4B shows S21.

FIG. 5 shows parameters of Examples 1 and 2 with different thicknesses of dielectric substrates.

FIGS. 6A and 6B show S-parameters of Example 1 and Example 2 obtained by the simulation. FIG. 6A shows S11 and FIG. 6B shows S21.

FIGS. 7A and 7B illustrate the transmission device to which the second exemplary embodiment is applied. FIG. 7A is a plan view, and FIG. 7B shows parameters of Example 3 used in the simulation.

FIGS. 8A and 8B show S-parameters of Example 3 obtained by the simulation. FIG. 8A shows S11 and FIG. 8B shows S21.

FIGS. 9A and 9B illustrate the transmission device to which the third exemplary embodiment is applied. FIG. 9A is a plan view, and FIG. 9B shows parameters of Example 4 used in the simulation.

FIGS. 10A and 10B show S-parameters of Example 4 obtained by the simulation. FIG. 10A shows S11 and FIG. 10B shows S21.

### DESCRIPTION OF EMBODIMENTS

Hereinafter, the exemplary embodiment of the present invention will be described in detail with reference to the accompanying drawings. In the exemplary embodiment, a microstrip antenna is used as an example to describe a transmission device. A transmission device is a device that transmits a signal, and a coaxial cable is connected to the signal input/output via a connector. A transmission device does not include an antenna element. Therefore, the transmission device may be used as a microstrip antenna by being connected with an antenna element, or may be used as a filter by being connected with a filter element that extracts a specific frequency signal from the signal. Furthermore, elements with other functions may be connected to the transmission device.

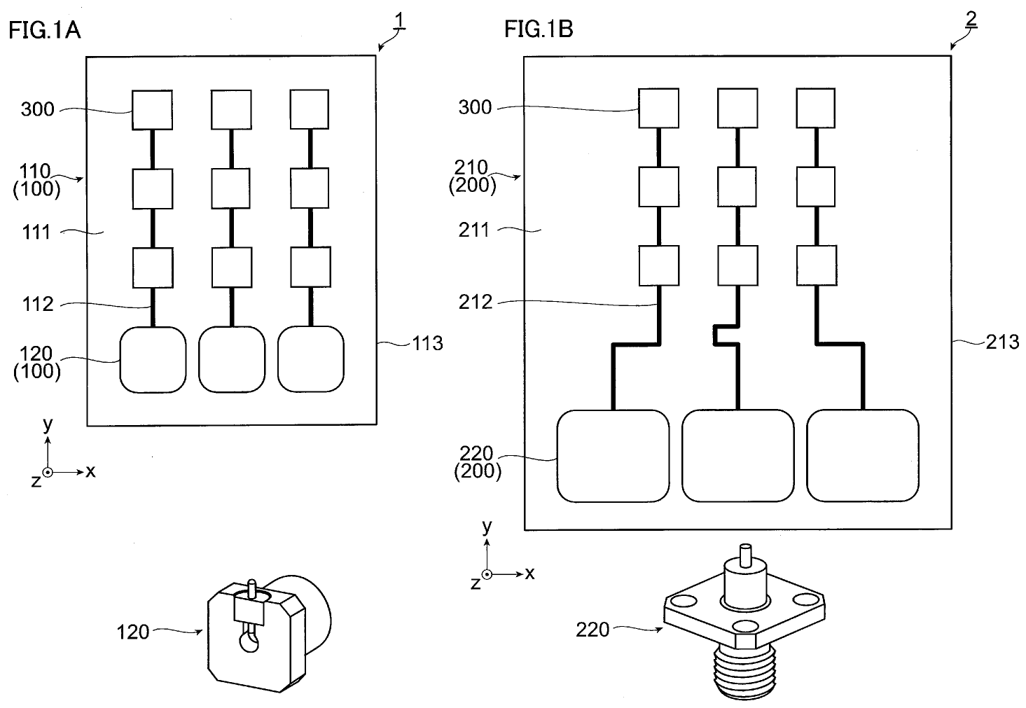

FIGS. 1A and 1B illustrate a microstrip antenna in a millimeter wave band. FIG. 1A illustrates a microstrip antenna 1 using a connector 120 with a small outer dimension, and FIG. 1B illustrates a microstrip antenna 2 using a connector 220 with a large outer dimension. In FIG. 1A, the microstrip antenna 1 is shown at an upper side of the paper and a perspective view of the connector 120 is shown at a lower side of the paper. Similarly, in FIG. 1B, the microstrip antenna 2 is shown at the upper side of the paper and a perspective view of the connector 220 is shown at the lower side of the paper. In the microstrip antenna 1 in FIG. 1A, a direction to the right of the paper is referred to as x direction, a direction to the upper side of the paper is referred to as y direction, and a direction to a surface of the paper is referred to as z direction. The same is applied to the microstrip antenna 2 in FIG. 1B. Here, it is assumed that the microstrip antenna 1 and the microstrip antenna 2 transmit and receive radio waves in the millimeter wave band.

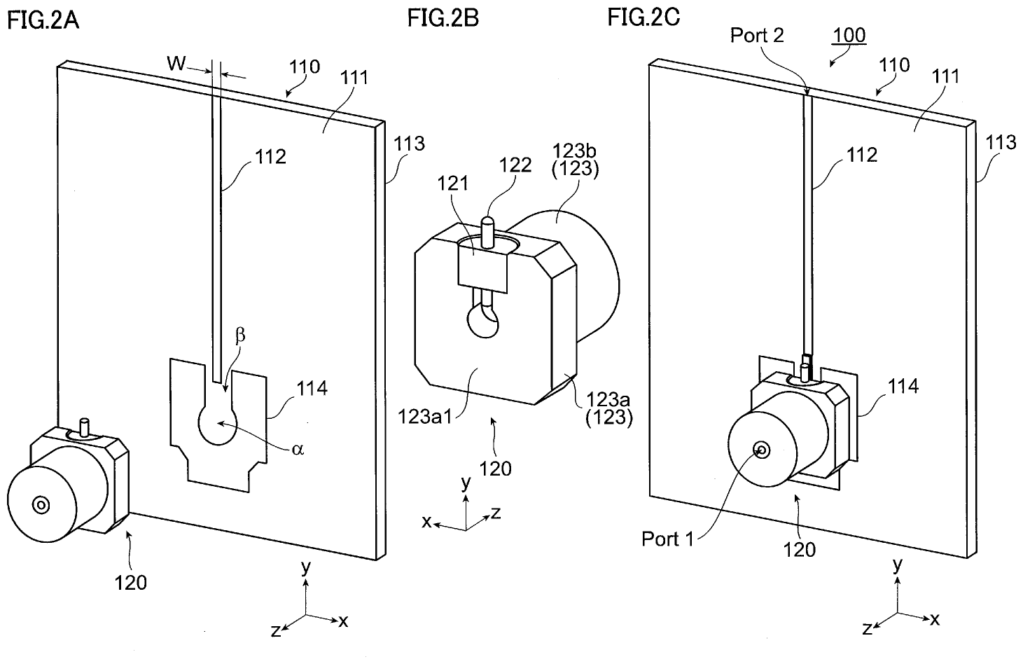

The microstrip antenna 1 shown in FIG. 1A includes a transmission device 100 and a radiating element 300. The transmission device 100 includes a transmission substrate 110 and the connector 120. The transmission substrate 110 includes a plate-shaped dielectric substrate 111, a feeding line 112 provided on one side of the dielectric substrate 111 (hereinafter referred to as a front surface), and a ground conductor 113 (only the sign thereof is denoted) provided on the other side of the dielectric substrate 111 back surface). The (hereinafter referred to as a transmission substrate 110 includes a capacitive coupling conductor 114 (see FIG. 2A or the like described later) on the front surface, but illustration thereof is omitted in FIG. 1A. The radiating element 300 is provided to be connected to the feeding line 112 of the dielectric substrate 111. The radiating element 300 of the microstrip antenna 1 transmits and receives radio waves, and is just denoted here as radiating element 300.

The dielectric substrate 111 is configured by, for example, impregnating a glass fabric base with epoxy resin, polyimide resin, fluorine resin or the like. The feeding line 112 and the ground conductor 113 are composed of conductors such as copper (Cu) foil. Here, the conductor means a conductor that is a good conductor of electricity. The feeding line 112 is provided on the front surface of the dielectric substrate 111 in a shape of a strip with a predetermined width. The width of the feeding line 112 is set according to a characteristic impedance with respect to the signal to be transmitted. The ground conductor 113 is provided to cover the entire back surface of the dielectric substrate 111. The ground conductor 113 does not necessarily have to cover the entire back surface of the dielectric substrate 111, but only needs to be provided to face the feeding line 112. Here, the transmission substrate 110 is a dielectric substrate 111 in which a conductor such as copper (Cu) foil is provided on both sides and the copper foil is processed into the feeding line 112 and ground conductor 113. In other words, the transmission substrate 110 includes the dielectric substrate 111 as well as the feeding line 112 and ground conductor 113. The transmission substrate 110 is sometimes described as a printed circuit board. The configuration in which the feeding line 112 is provided on the front surface of the dielectric substrate 111 and the ground conductor 113 is provided on the back surface thereof may be described as a microstrip line.

The radiating element 300 shown in FIG. 1A is a so-called patch antenna, which has a radiating part and a ground plate. The radiating part is composed of a conductor on the front surface of the dielectric substrate 111. In FIG. 1A, a planar shape of the radiating section is square as one specific example. The ground conductor 113 is provided on the back surface of the dielectric substrate 111 to function as the ground plate. The ground conductor 113 is provided to face the radiating part. The radiating part is configured by processing the same conductor as the feeding line 112. Hereinafter, the radiating part is referred to as the radiating element 300, and description of the ground plate will be omitted. The radiating element 300 does not have to be a patch antenna as long as being connected to and fed by the feeding line 112.

The microstrip antenna 1 shown in FIG. 1A has nine radiating elements 300 on the front surface of the dielectric substrate 111, three of which are arranged in the right direction on the paper (the x direction) and three of which are arranged in the upper direction on the paper (the y direction). The feeding line 112 connects the three radiating elements 300 in sequence in the upper direction on the paper (the y direction). The microstrip antenna 1 shown in FIG. 1A includes three feeding lines 112. One end of each of the feeding lines 112 (an end at the lower side on the paper and in the −y direction) is connected to the connector 120. Here, the connector 120 is, for example, SMPM with a small outer dimension. If the outer dimension of the connector 120 is small, the connector 120 is arranged at the pitch of arrangement of the radiating elements 300 in the left-right direction on the paper (±x direction).

An antenna with multiple radiating elements, such as the microstrip antenna 1, is used for wireless communication in MIMO (Multiple Input Multiple Output) method in which signals are transmitted simultaneously from multiple radiating elements on the transmitting side and the signals are received by multiple radiating elements on the receiving side to speed up communication, or used for shaping the shape of radiated radio waves (for example, beamforming or the like).

The microstrip antenna 2 shown in FIG. 1B includes a transmission device 200 and a radiating element 300. The transmission device 200 includes a transmission substrate 210 and a connector 220. The transmission substrate 210 includes a dielectric substrate 211, a feeding line 212 provided on a front surface of the dielectric substrate 211, and a ground conductor 213 (only the sign thereof is denoted) provided on a back surface of the dielectric substrate 211. The radiating element 300 is provided to be connected to the feeding line 212 of the dielectric substrate 211.

The microstrip antenna 2 shown in FIG. 1B has nine radiating elements 300 arranged on the front surface of the dielectric substrate 211. The microstrip antenna 2 has three feeding lines 212 to connect the three radiating elements 300 in the upper direction on the paper (the y direction). One end of each of the feeding lines 212 (an end at the lower side on the paper and in the −y direction) is connected to the connector 220. Since the microstrip antenna 1 and the microstrip antenna 2 transmit and receive radio waves in the same millimeter wave band, the shape and arrangement of the nine radiating elements 300 are the same as in the microstrip antenna 1. Here, the connector 220 is, for example, SMA (Sub Miniature Type A) whose outer dimension is larger than the outer dimension of SMPM described above. As shown in FIG. 1B, in a case where the outer dimension of the connector 220 is large, the connectors 220 are not arranged in a pitch as the arrangement of the radiating elements 300 in the left-right direction on the paper (±x direction). Therefore, the connectors 220 are arranged at a pitch larger than the pitch of the arrangement of the radiating elements 300 in a lateral direction (x direction) on the paper surface. Thus, the feeding lines 212 are configured to be bent to absorb the difference in pitch.

Based on the above description, the dielectric substrate 211 of the microstrip antenna 2 using the connector 220 with a large outer dimension is larger than the dielectric substrate 111 of the microstrip antenna 1 using the connector 120 with a small outer dimension. In addition, the feeding line 212 of the microstrip antenna 2 using the connector 220 with a large outer dimension is longer than the feeding line 112 of the microstrip antenna 1 using the connector 120 with a small outer dimension, which leads to a big loss. Therefore, it is preferable to use connectors with a small outer dimension for antennas that transmit and receive radio waves with short wavelengths such as the millimeter wave band.

Next, the connectors 120 and 220 will be explained.

As can be seen from the perspective view shown in the lower side of FIG. 1B, in the case of the connector 220 with a large outer dimension such as SMA, a through hole is provided in the dielectric substrate 211, and the connector 220 is inserted and mounted from the back surface on which the ground conductor 213 of dielectric substrate 211 is provided. In other words, an outer conductor of the connector 220 contacts the ground conductor 213, and an inner conductor (a core wire) of the connector 220 is connected to the feeding line 212 through the through hole.

On the other hand, as can be seen from the perspective view shown in the lower side of FIG. 1A, the connector 120 with a small outer dimension such as SMPM is mounted on the front surface of the dielectric substrate 111, that is, the front surface where the feeding line 112 is provided. In other words, an outer conductor of the connector 120 and the ground conductor 113 provided on the dielectric substrate 111 are placed on different surfaces of the transmission substrate 110. Therefore, the outer conductor of the connector 120 and the ground conductor 113 of the transmission substrate 110 were connected via a through hole or the like provided with a conductor inside thereof (for example, a metal-plated through hole) in the dielectric substrate 111. However, formation of such a through hole increases the manufacturing cost of the microstrip antenna 1.

The transmission device 100 to which the exemplary embodiment is applied operates without connecting (even without contact) the ground conductor 113 of the transmission substrate 110 to the outer conductor 123 of the connector 120 (see FIG. 2B described later). In other words, the transmission device 100 to which the exemplary embodiment is applied does not require a through hole to be provided.

### The First Exemplary Embodiment

FIGS. 2A to 2C illustrate the transmission device 100 to which the first exemplary embodiment is applied. FIG. 2A is a perspective view in a state where the transmission substrate 110 and the connector 120 are in close proximity, FIG. 2B is a perspective view of the connector 120, and FIG. 2C is a perspective view in a state where the connector 120 is mounted on the transmission substrate 110. In FIGS. 2A to 2C, the x, y, and z directions are set as shown in the figures.

As shown in FIG. 2A, the transmission substrate 110 includes the dielectric substrate 111, the feeding line 112, the ground conductor 113, and a capacitive coupling conductor 114. The feeding line 112 and the capacitive coupling conductor 114 are provided on the front surface of the dielectric substrate 111 (a surface in the +x direction). The feeding line 112 and the capacitive coupling conductor 114 are configured by a conductor (such as a copper foil) provided on the front surface of the dielectric substrate 111. The feeding line 112 and the capacitive coupling conductor 114 are not connected to each other.

A planar shape of the feeding line 112 (viewed from the +z direction) is a strip shape as described above. A width W of the feeding line 112 is determined by a relative permittivity of the dielectric substrate 111 or the like, and the width W is set to a characteristic impedance for a signal transmission. The characteristic impedance is, for example, 50Ω.

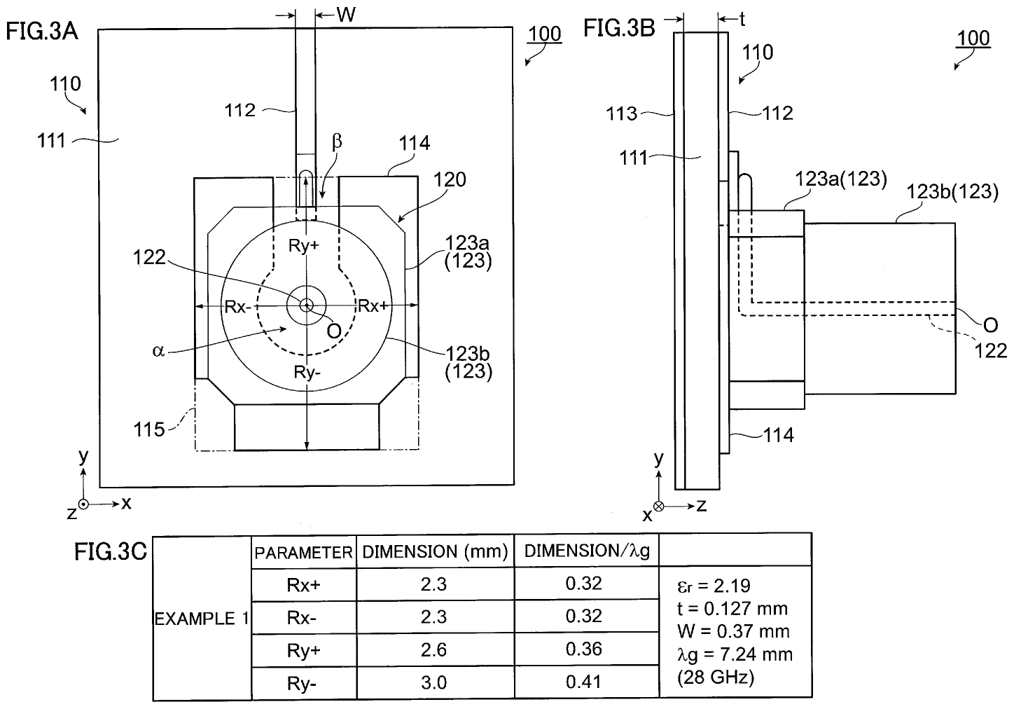

The capacitive coupling conductor 114 is a conductor whose planar shape is U-shaped. A shape of the capacitive coupling conductor 114 surrounding an outer edge thereof is square 115 (see FIG. 3B. Here, it is rectangular). A circular opening a is provided at a center portion of the capacitive coupling conductor 114, and a gap β from the outer edge to the opening a is provided at upper side (in the +y direction). In other words, the shape of the capacitive coupling conductor 114 surrounding the outer edge thereof is square, and the capacitive coupling conductor 114 has U-shape whose upper side is opened. A lower end (an end in the −y direction) of the feeding line 112 is positioned at the gap β of the capacitive coupling conductor 114. Furthermore, a part of the capacitive coupling conductor 114 is removed from the square 115 at a lower right (an end in the −y and +x directions) and a lower left (an end in the −y and −x directions). The shape of the capacitive coupling conductor 114 surrounding the outer edge thereof is not limited to a square, a circle to be described later, or a pentagon, but may be a shape in which a part is removed from these shapes or in which another shape is added to these shapes. The shape of the capacitive coupling conductor 114 surrounding the outer edge thereof is a shape that encloses (connects) along the outer edge of the capacitive coupling conductor 114 as if no gap is provided and further encloses to include a part that has been removed. By making the planar shape of the capacitive coupling conductor 114 U-shaped, the feeding line 112 and the capacitive coupling conductor 114 are configured by one layer of conductor.

The ground conductor 113 is provided on the entire back surface of the dielectric substrate 111, though only sign thereof is indicated. Therefore, the feeding line 112 and the capacitive coupling conductor 114 face the ground conductor 113 across the dielectric substrate 111.

The connector 120 is an SMPM, and includes an insulator 121, an inner conductor 122, and an outer conductor 123 as shown in FIG. 2B. The inner conductor 122 is a conductor through which a signal passes, and is sometimes referred to as a core wire. The inner conductor 122 is bent in an L-shape. That is, the inner conductor 122 includes a portion that is perpendicular to the dielectric substrate 111 and a portion that is parallel to the dielectric substrate 111. A top end of the portion of the inner conductor 122 that is parallel to the dielectric substrate 111 is connected to the feeding line 112 of the transmission substrate 110.

The outer conductor 123 includes a mounting portion 123a that is mounted on the transmission substrate 110 and a connecting portion 123b that is connected to the coaxial cable. The mounting portion 123a has a flat bottom surface 123a1, which is a surface at the side of the transmission substrate 110 (in the −z direction). The bottom surface 123a1 of the mounting portion 123a of the connector 120 is connected to the capacitive coupling conductor 114 of the transmission substrate 110. The connecting portion 123b may be configured to be easily connected to a connector on a side of the coaxial cable by a push-on locking mechanism.

The insulator 121 is provided between the inner conductor 122 and the outer conductor 123. The insulator 121 provides insulation against direct current between the inner conductor 122 and the outer conductor 123. The inner conductor 122 and the outer conductor 123 are composed of copper or copper alloy. The insulator 121 is composed of a resin such as polytetrafluoroethylene which has low loss to a high frequency signal. The shape of the connector 120 (the insulator 121, the inner conductor 122, and the outer conductor 123) shown in FIG. 2B is a specific example, thus it may be other shapes.

As shown in FIG. 2C, the connector 120 is mounted on the dielectric substrate 111. Connection between the inner conductor 122 and the feeding line 112 and connection between the outer conductor 123 and the capacitive coupling conductor 114 can be made by solder or the like. The inner conductor 122 of the connector 120 is referred to as Port 1, and the upper end of the feeding line 112 (the end in the +y direction) is referred to as Port 2.

FIGS. 3A to 3C illustrate the transmission device 100 to which the first exemplary embodiment is applied. FIG. 3A is a plan view, FIG. 3B is a side view, and FIG. 3C shows parameters of Example 1 used in a simulation. In FIG. 3A, the right direction on the paper is the x direction, the upper direction on the paper is the y direction, and the front surface direction on the paper is the z direction. In FIG. 3B, the right direction on the paper is the z direction, the upper direction on the paper is the y direction, and the back surface direction on the paper is the z direction. The connector 120 is a male type.

The plan view of FIG. 3A is seen from a side of the connector 120 mounted on the transmission substrate 110. The connector 120 is provided to overlap the feeding line 112 and the capacitive coupling conductor 114 on the transmission substrate 110. In FIG. 3A, the feeding line 112 and the capacitive coupling conductor 114 are shown with thick lines, and the connector 120 is shown with thin lines. The capacitive coupling conductor 114 which is hidden due to the connector 120 is shown with a dashed line. Here, the center of a portion of the inner conductor 122 of the connector 120 that is perpendicular to the dielectric substrate 111, namely, the center of the inner conductor 122 on a side to which the coaxial cable is connected is referred to as a center O of the connector 120. Then, a dimension from the center O of the connector 120 to an end of the capacitive coupling conductor 114 in the +x direction is referred to as Rx+, that to an end of the capacitive coupling conductor 114 in the −x direction is referred to as Rx−, that to an end of the capacitive coupling conductor 114 in the +y direction is referred to as Ry+, and that to an end of the capacitive coupling conductor 114 in the −y direction is referred to as Ry−.

The side view of FIG. 3B shows the transmission device 100 shown in FIG. 3A seen from the −x direction side. As described above, the transmission substrate 110 includes the dielectric substrate 111, the feeding line 112 and the capacitive coupling conductor 114 that are provided on the front surface of the dielectric substrate 111 (the surface in the +z direction), and the ground conductor 113 provided on the back surface of the dielectric substrate 111 (the surface in the −z direction). The mounting portion 123a of the outer conductor 123 of the connector 120 is connected to the capacitive coupling conductor 114, and the inner conductor 122 of the connector 120 is connected to the feeding line 112. In FIG. 3B, a portion of the inner conductor 122 hidden due to the outer conductor 123 of the connector 120 is shown with a dashed line.

As can be seen from FIG. 3B, the outer conductor 123 of the connector 120 and the ground conductor 113 of the transmission substrate 110 face each other via the dielectric substrate 111. There is no DC connection between the outer conductor 123 of the connector 120 and the ground conductor 113 of the transmission substrate 110. In other words, the outer conductor 123 of the connector 120 and the ground conductor 113 of the transmission substrate 110 are capacitively coupled via the capacitive coupling conductor 114. It is possible to increase the coupling capacitance by facing the capacitive coupling conductor 114 and the ground conductor 113 each other.

The shape of the top end of the feeding line 112 (the portion connected to the inner conductor 122 of the connector 120) is defined to facilitate connection with the inner conductor 122 of the connector 120. Area of the capacitive coupling conductor 114 is set according to the wavelength of the signal, the amount of capacitive coupling, as well as the shape of the bottom 123a1 of the mounting portion 123a in the outer conductor 123 of the connector 120.

FIG. 3C shows dimensions of parameters of the capacitive coupling conductor 114 when matched in 28 GHZ band. The relative permittivity εr of the dielectric substrate 111 is 2.19 and thickness t of the dielectric substrate 111 is 0.127 mm. 28 GHz is a frequency in free space. Effective wavelength λg in the dielectric substrate 111 can be obtained by λ/sqrt(εr) based on the wavelength A in free space and the relative permittivity εr of the dielectric substrate 111. In the case of 28 GHZ, the effective wavelength λg is 7.24 mm. Here, a characteristic impedance of the feeding line 112 is 50Ω, and a width W thereof is 0.37 mm. When the dimensions of the parameters of the capacitive coupling conductor 114 (Rx+, Rx−, Ry+, Ry−) are set as shown in FIG. 3C, values of the ratio between the dimensions of the (Rx+, Rx−, Ry+, Ry−) with the effective wavelength λg (dimension/λg) is set to be more than ¼ λg (0.25 λg) and less than ½ λg (0.5 λg). The above transmission device 100 is represented as Example 1. In FIG. 3C, Rx+ and Rx− are set to be the same value because the transmission device 100 is symmetrical in the left-right direction (±x direction) as shown in FIG. 3A, but the values of Rx+ and Rx− need not be the same.

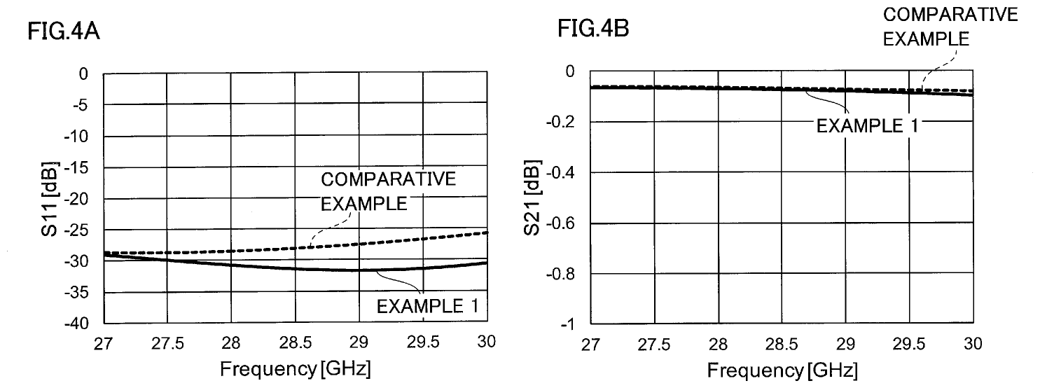

FIGS. 4A and 4B show S-parameters of Example 1 and comparative example obtained by the simulation. FIG. 4A shows S11 and FIG. 4B shows S21. S11 is a reflection characteristic at Port 1 shown in FIG. 2C, and S21 is a transmission characteristic from Port 1 to Port 2 shown in FIG. 2C. In FIG. 4A, the horizontal axis shows frequency [GHz] and the vertical axis shows S11 [dB]. In FIG. 4B, the horizontal axis shows frequency [GHz] and the vertical axis shows S21 [dB]. In FIGS. 4A and 4B, as a comparative example, S11 and S12 are shown with dashed lines in a case where a transmission substrate with DC connection between the outer conductor 123 of the connector 120 and the ground conductor 113 of the dielectric substrate 111 is used.

As shown in FIG. 4A, S11 in Example 1 is equal to or less than −20 dB in the frequency range of 27 GHz to 30 GHz. Moreover, S11 of Example 1 is smaller than S11 of the comparative example. As can be seen from S21 shown in FIG. 4B, Example 1 has less loss in the frequency range of 27 GHZ to 30 GHz similar to the comparative example. In the transmission device 100 of Example 1, the outer conductor 123 of the connector 120 is capacitively coupled with the ground conductor 113 of the transmission substrate 110 via the capacitive coupling conductor 114 and there is no DC connection. However, the transmission characteristics of the transmission device 100 of Example 1 (S11 and S21) have a small difference (equivalent) compared with the transmission device in which the outer conductor 123 of the connector 120 is connected in DC manner with the ground conductor 113 of the transmission substrate 110. In other words, in the transmission device 100 of Example 1, by providing the capacitive coupling conductor 114 to capacitively couple the outer conductor 123 of the connector 120 with the ground conductor 113 of the transmission substrate 110, it is not required to provide a through hole in the dielectric substrate 111 to connect the outer conductor 123 of the connector 120 in a DC manner with the ground conductor 113 of the transmission substrate 110. Therefore, the manufacturing cost of the transmission device 100 is suppressed.

In the above, it has been explained that the dimensions from the center O of the connector 120 to the outer edge of the capacitive coupling conductor 114 (Rx+, Rx−, Ry+, Ry−) are more than ¼ and less than ½ of the effective wavelength λg. This is because, when the dimensions from the center O of the connector 120 to the outer edge of the capacitive coupling conductor 114 (Rx+, Rx−, Ry+, Ry−) are equal to or less than ¼ of the effective wavelength λg, the amount of capacitive coupling between the outer conductor 123 of the connector 120 and the ground conductor 113 of the transmission substrate 110 becomes small, thus it is difficult to maintain the outer conductor 123 of the connector 120 at the ground potential. On the other hand, when the dimensions from the center O of the connector 120 to the outer edge of the capacitive coupling conductor 114 (Rx+, Rx−, Ry+, Ry−) are ½ of the effective wavelength λg, excitation occurs and radio waves are radiated (becoming an antenna). Therefore, it is preferable that the dimensions from the center O of the connector 120 to the outer edge of the capacitive coupling conductor 114 (Rx+, Rx−, Ry+, Ry−) are set to be more than ¼ and less than ½ of the effective wavelength λg. When the dimensions from the center O of the connector 120 to the outer edge of the capacitive coupling conductor 114 are 2.3 mm (in the case of Rx+ and Rx−), the frequency corresponding to ¼ λg is about 16 GHz and the frequency corresponding to ½ λg is about 32 GHz. When the dimension from the center O of the connector 120 to the outer edge of the capacitive coupling conductor 114 is 2.6 mm (in the case of Ry+), the frequency corresponding to ¼ λg is about 20 GHz and the frequency corresponding to ½ λg is about 39 GHz. When the dimension from the center O of the connector 120 to the outer edge of the capacitive coupling conductor 114 is 3.0 mm (in the case of Ry−), the frequency corresponding to ¼ λg is about 17 GHz and the frequency corresponding to ½ λg is about 33 GHZ. Therefore, as shown in Example 1 of FIGS. 4A and 4B, in the frequency range of 27 GHz to 30 GHZ, the transmission characteristics (S11, S21) have a small difference (equivalent) compared with the transmission device in which the outer conductor 123 of the connector 120 is connected in DC manner with the ground conductor 113 of the transmission substrate 110. In this way, the shape of the capacitive coupling conductor 114 can be set based on the effective wavelength λg as in Example 1.

As will be described later, when n is an integer equal to or greater than 2, the difference will be small (equivalent) compared with the transmission device in which the outer conductor 123 of the connector 120 is connected in DC manner with the ground conductor 113 of the transmission substrate 110, except for the frequency that is n×½ λg.

Next, the thickness t of the dielectric substrate 111 is described.

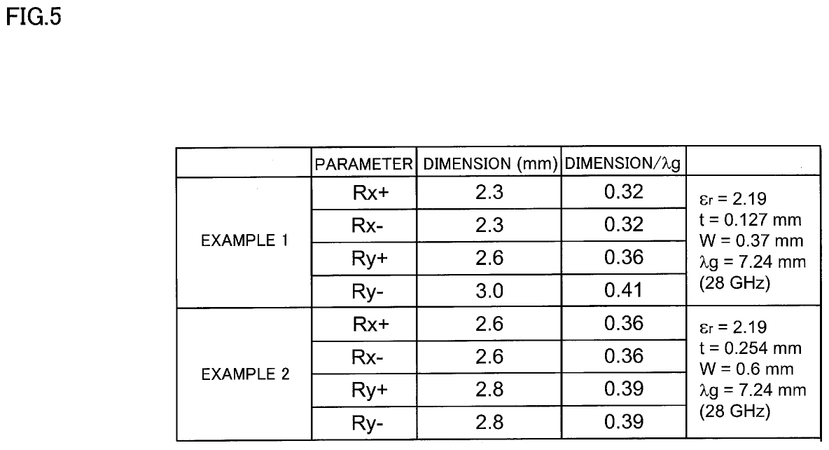

FIG. 5 shows parameters of Examples 1 and 2 with different thicknesses t of the dielectric substrates 111. Example 1 is a case where the thickness t of the dielectric substrate 111 is 0.127 mm, and Example 2 is a case where the thickness t of the dielectric substrate 111 is 0.254 mm. Example 1 is the Example 1 shown in FIGS. 3A to 4B. In Example 2, the dimensions of the parameters of the capacitive coupling conductor (Rx+, Rx−, Ry+, Ry−) were adjusted to match in the 28 GHz band. In Example 2, the width W of the feeding line 112 is 0.6 mm to set the characteristic impedance to 50Ω because the dielectric substrate 111 is larger compared with Example 1.

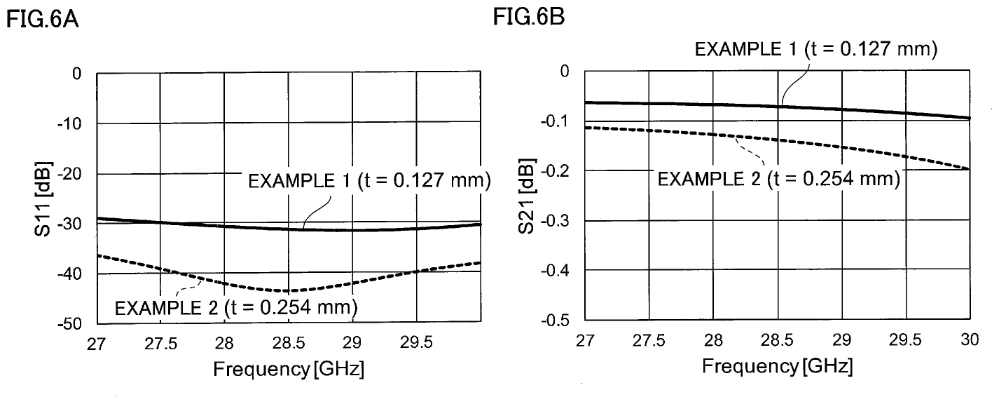

FIGS. 6A and 6B show S-parameters of Example 1 and Example 2 obtained by the simulation. FIG. 6A shows S11 and FIG. 6B shows S21. The horizontal axis and the vertical axis in FIGS. 6A and 6B are the same as those in FIGS. 4A and 4B. Example 1 shown in FIGS. 6A and 6B is the same as that shown in FIGS. 4A and 4B.

As shown in FIG. 6A, in Example 2 where the thickness t of the dielectric substrate 111 is twice to be 0.254 mm, S11 is smaller compared with Example 1 where the thickness t of the dielectric substrate 111 is 0.127 mm. On the other hand, as shown in FIG. 6B, the pass characteristic in Example 2 is slightly lower compared with Example 1, thus it can be seen that the radiation loss increases. However, the difference in transmission characteristics (S11 and S21) between Example 1 and Example 2 is small, and equivalent characteristics can be obtained. In other words, even if the thickness t of the dielectric substrate 111 is changed, equivalent characteristics can be obtained by adjusting the shape of the capacitive coupling conductor 114.

### The Second Exemplary Embodiment

In the transmission device 100 to which the first exemplary embodiment is applied, the planar shape of the capacitive coupling conductor 114 is U-shaped, and the shape surrounding the outer edge is the square 115. In the transmission device 100′ to which the second exemplary embodiment is applied, the planar shape of the capacitive coupling conductor 114′ is U-shaped, however, the shape surrounding the outer edge is circular 115′.

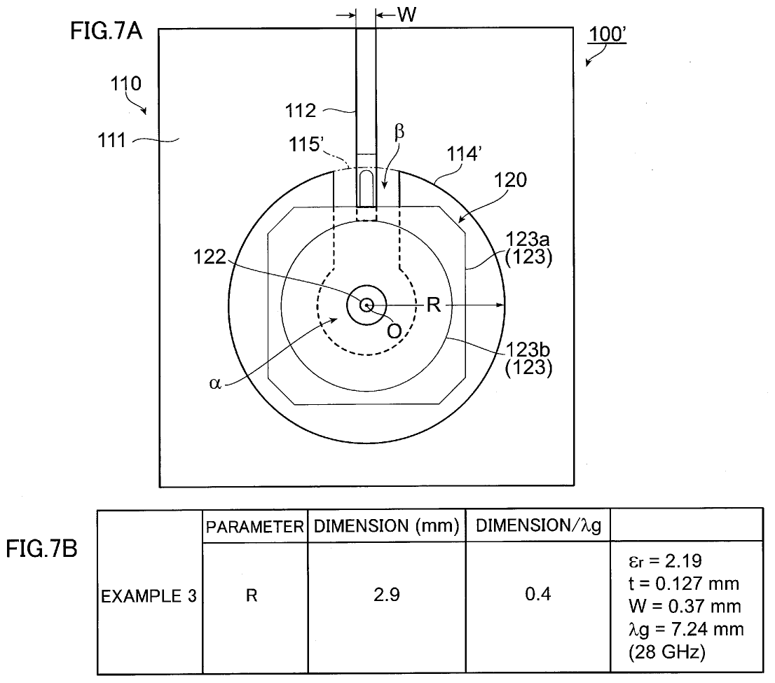

FIGS. 7A and 7B illustrate the transmission device 100′ to which the second exemplary embodiment is applied. FIG. 7A is a plan view, and FIG. 7B shows parameters of Example 3 used in the simulation. The x, y, and z directions shown in FIG. 7A are the same as those in FIG. 4A.

As shown in FIG. 7A, the shape of the capacitive coupling conductor 114′ surrounding the outer edge is circular 115′ with a radius R. The capacitive coupling conductor 114′ includes a circular opening α at a center portion and a gap β from the outer edge (circular 115′) to the opening α. The other configurations are similar to those of the transmission device 100 described in FIGS. 4A and 4B. Therefore, the same signs are used and explanations will be omitted.

The parameter of the capacitive coupling conductor 114′ shown in FIG. 7B is the radius R of the circular 115′, which is the dimension from the center of the connector 120 to the outer edge of the capacitive coupling conductor 114′. The relative permittivity εr of the dielectric substrate 111 is 2.19. Therefore, the effective wavelength λg is 7.24 mm. The thickness t of the dielectric substrate 111 is 0.127 mm as in Example 1. Therefore, the width W of the feeding line 112 is 0.37 mm as in Example 1. The radius R is set to 2.9 mm, which is considered to have good characteristics at 28.5 GHz. Even in this case, the value of the ratio (R/λg) between the dimension from the center O of the connector 120 to the edge of the capacitive coupling conductor 114′ (radius R) with the effective wavelength λg is 0.4, which is more than ¼ λg and less than ½ λg.

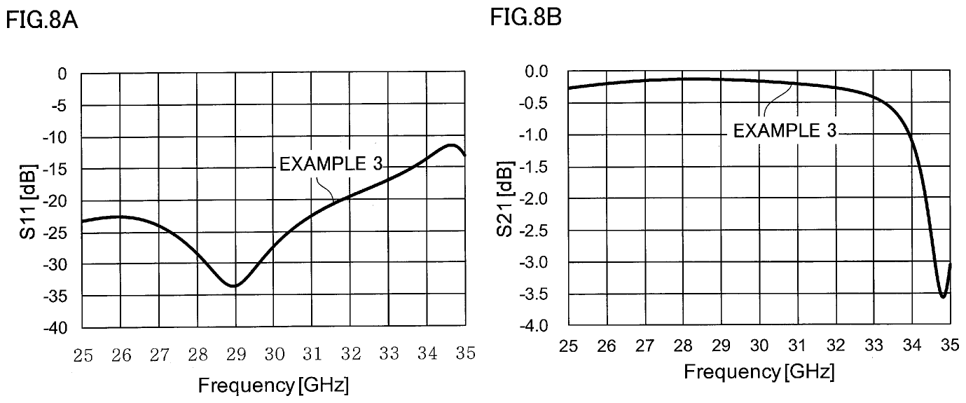

FIGS. 8A and 8B show S-parameters of Example 3 obtained by the simulation. FIG. 8A shows S11 and FIG. 8B shows S21. The horizontal axis and the vertical axis in FIGS. 8A and 8B are the same as in FIGS. 4A and 4B. The relative permittivity εr of the dielectric substrate 111 is 2.19.

As shown in FIG. 8A, S11 of Example 3 is small near 29 GHz as in Example 1 shown in FIG. 4A, on the other hand, S11 of Example 3 is large at frequencies lower than 29 GHz and higher than 29 GHz. This is considered that, in addition to the fact that the radius R is set to a value that is considered to have good characteristics at 28.5 GHZ, is due to the mismatch that occurs between the transmission mode of the coaxial cable and the transmission mode of the transmission substrate 110 constituting the microstrip line. For this reason, the shape surrounding the outer edge of the capacitive coupling conductor 114 is preferably the square 115 of Example 1.

As shown in FIG. 8B, S21 in Example 3 significantly decreases near 34.7 GHZ. This is due to the fact that the frequency corresponding to ½ λg is about 35 GHz at a dimension of 2.9 mm (radius R) from the center of the connector 120 to the outer edge of the capacitive coupling conductor 114′. On the other hand, at a dimension of 2.9 mm (radius R) from the center of the connector 120 to the outer edge of the capacitive coupling conductor 114′, the frequency corresponding to ¼ λg is about 17 GHZ. Thus, the transmission device 100′ operates in the frequency band more than 17 GHZ and less than 35 GHZ. As described above, except for the vicinity of 35 GHZ, the transmission device 100′ operates in an even higher frequency band.

### Third Exemplary Embodiment

In the transmission device 100 to which the first exemplary embodiment is applied, the planar shape of the capacitive coupling conductor 114 is U-shaped, and the shape surrounding the outer edge is the square 115. In a transmission device 100″ to which the third exemplary embodiment is applied, the planar shape of the capacitive coupling conductor 114″ is U-shaped, however, the shape surrounding the outer edge is a pentagon (here, a regular pentagon) 115″.

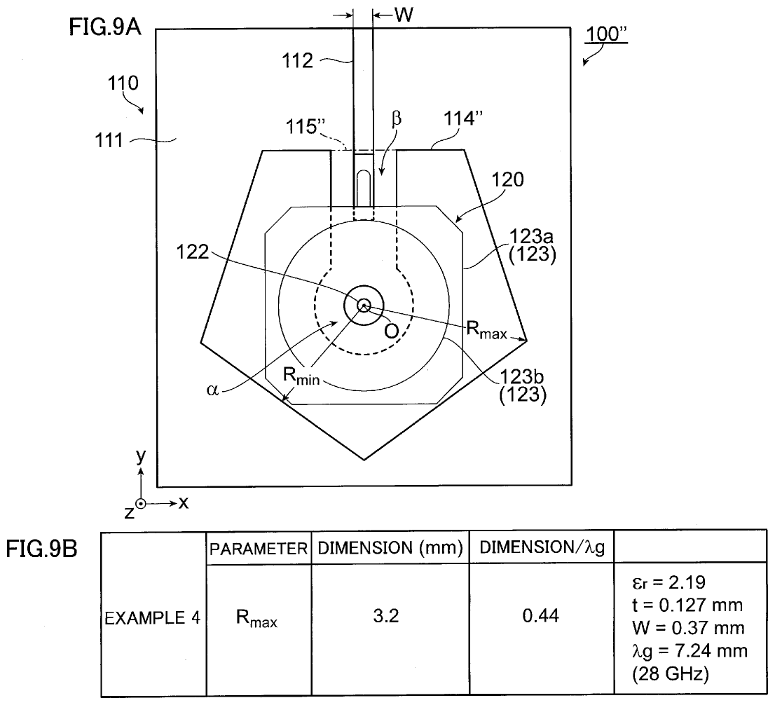

FIGS. 9A and 9B illustrate the transmission device 100″ to which the third exemplary embodiment is applied. FIG. 9A is a plan view, and FIG. 9B shows parameters of Example 4 used in the simulation. The x, y, and z directions shown in FIG. 9A are the same as in FIG. 4A.

As shown in FIG. 9A, the shape surrounding the outer edge of the capacitive coupling conductor 114″ is the pentagon 115″. The dimension from the center of the connector 120 to an apex of the pentagon 115″ is R max. The capacitive coupling conductor 114″ includes a circular opening α at a center portion and a gap β from the outer edge (pentagon 115″) to the opening α. The gap β is provided in one side of the pentagon 115″. The other configurations are similar to those of the transmission device 100 described in FIGS. 4A and 4B. Therefore, the same signs are used and explanations will be omitted.

The parameter of the capacitive coupling conductor 114″ shown in FIG. 9B is R max, which is the dimension from the center of the connector 120 to the outer edge of the capacitive coupling conductor 114″ and is the dimension from the center of the pentagon 115″ to the apex thereof. The relative permittivity εr of the dielectric substrate 111 is 2.19. Therefore, the effective wavelength λg is 7.24 mm. The thickness t of the dielectric substrate 111 is 0.127 mm as in Example 1. Therefore, the width W of the feeding line 112 is 0.37 mm as in Example 1. The R max is set to 3.2 mm, which is considered to have good characteristics at 28.5 GHZ. Even in this case, the value of the ratio (R max/λg) between the maximum dimension (R max) from the center O of the connector 120 (the center of the pentagon 115″) to the edge side of the capacitive coupling conductor 114″ with the effective wavelength λg is 0.44, which is more than ¼ λg and less than ½λg.

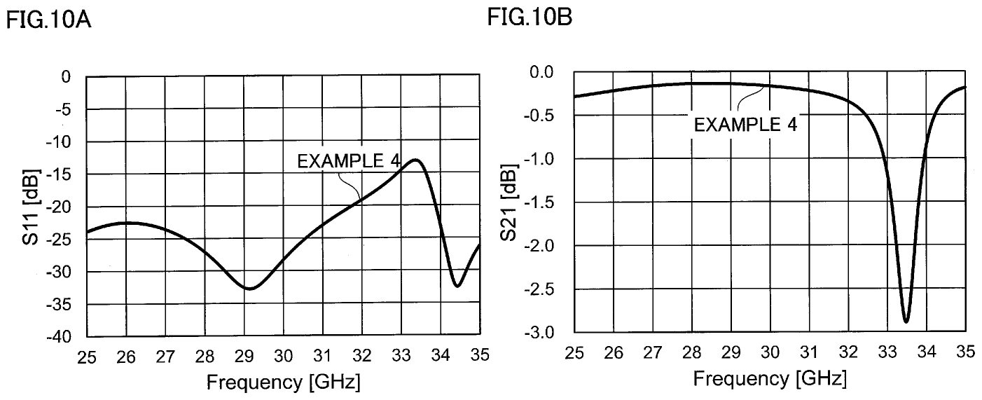

FIGS. 10A and 10B show S-parameters of Example 4 obtained by the simulation. FIG. 10A shows S11 and FIG. 10B shows S21. The horizontal axis and the vertical axis in FIGS. 10A and 10B are the same as in FIGS. 4A and 4B. The relative permittivity εr of the dielectric substrate 111 is 2.19.

As shown in FIG. 10A, S11 of Example 4 is small near 29 GHz as in Example 1 shown in FIG. 4A, on the other hand, S11 of Example 4 is large at frequencies lower than 29 GHz and higher than 29 GHz. Note that S11 is again small near 34.4 GHz.

As shown in FIG. 10B, in Example 4, S21 significantly decreases near 33.5 GHZ. At the dimension of R max (3.2 mm) from the center to the apex of pentagon 115″, the frequency corresponding to ½ λg is about 32 GHz. However, at 32 GHZ, there is little decrease in S21. On the other hand, at a dimension of R min (2.6 mm) from the center to the side of pentagon 115″, the frequency corresponding to ½ λg is about 39 GHz. The frequency of 33.5 GHZ at which S21 decreases lies between these frequencies.

In a case where the shape surrounding the outer edge of the capacitive coupling conductor 114′ shown in Example 3 is circular 115′, the dimension from the center of the connector 120 to the outer edge of the capacitive coupling conductor 114′ does not change. Therefore, the frequency corresponding to ½ λg matches the calculated frequency. However, in a case where the shape surrounding the outer edge of the capacitive coupling conductor 114″ is the pentagon 115″, the dimension from the center of the connector 120 to the outer edge of the capacitive coupling conductor 114″ changes. R max is the maximum dimension from the center to the outer edge of the pentagon 115″, and R min is the minimum dimension from the center to the outer edge of the pentagon 115″. The larger the dimension is, the lower the frequency corresponding to ½ λg is, while the smaller the dimension is, the higher the frequency corresponding to ½ λg is. Therefore, in a case where the shape surrounding the outer edge of the capacitive coupling conductor 114″ is the pentagon 115″, the frequency at which S21 decreases is determined between the maximum dimension (R max) and the minimum dimension (R min) from the center of the connector 120 to the outer edge of the capacitive coupling conductor 114″. Therefore, in order to suppress the decrease in S21 in the frequency band, it is preferable to use, as the upper limit, the frequency where the maximum dimension (R max) from the center of the connector 120 to the outer edge of the capacitive coupling conductor 114″ corresponds to ½ λg. Moreover, it is preferable to use, as the lower limit, the frequency where the minimum dimension (R min) from the center of the connector 120 to the outer edge of the capacitive coupling conductor 114″ corresponds to ¼λg. In this way, the decrease in S21 is suppressed between the frequencies of the lower limit and the upper limit. The shape of the capacitive coupling conductor can be set based on the desired frequency band. If the maximum dimension from the center of the connector 120 to the outer edge of the capacitive coupling conductor 114″ is the same as the minimum dimension from the center of the connector 120 to the outer edge of the capacitive coupling conductor 114″, it is sufficient that the maximum dimension and the minimum dimension are the same.

As shown in FIG. 10B, S21 increases again above 33.5 GHZ, and as shown in FIG. 10A, S11 also decreases. Therefore, when n is an integer equal to or greater than 2, the transmission device operates as a transmission device with a wider frequency band, except for the frequency at which n×¼ λg. Therefore, the shape of the capacitive coupling conductor 114″ can be set according to the frequency band.

In the first, second, and third exemplary embodiments, the capacitive coupling conductors 114, 114′ and 114″ have been described. The capacitive coupling conductors 114, 114′ and 114″ constitute a capacitance (capacitor) with the ground conductor 113. Therefore, the area of the capacitive coupling conductors 114, 114′ and 114″ depends on the coupling capacitance between the outer conductor 123 of the connector 120 and the ground conductor 113 of the transmission substrate 110. On the other hand, the dimension from the center of the connector 120 to the edges of the capacitive coupling conductors 114, 114′ and 114″ affects the frequency of the signal. Therefore, the shape of the capacitive coupling conductors 114, 114′ and 114″ should be set according to the coupling capacitance between the outer conductor 123 of the connector 120 and the ground conductor 113 of the transmission substrate 110 and according to the frequency of the signal to be transmitted. In this way, it is possible to suppress the manufacturing cost of the transmission devices 100, 100′, and 100″ because it is not necessary to provide through holes or the like in the dielectric substrate 111.

The shapes surrounding the outer edges of the capacitive coupling conductors 114, 114′ and 114″ described in the first, second, and third exemplary embodiments are square, circular, and pentagon (regular pentagon). The shape surrounding the outer edge of the capacitive coupling conductors can be polygonal (including quadrilateral and pentagonal), circular, oval or the like. As in the capacitive coupling conductor 114 shown in the first exemplary embodiment, the shape of the capacitive coupling conductors may be a shape in which a part is removed therefrom or in which another shape is added thereto. In the microstrip antenna 1 shown in FIG. 1A, the pitch of the radiating element 300 in the left-right direction (±x direction) is determined based on the wavelength of the radio waves transmitted and received by the radiating element 300. As the wavelength of the radio wave becomes shorter, the pitch of the radiating element 300 in the left-right direction (±x direction) also becomes shorter. Therefore, the shape surrounding the edges of the capacitive coupling conductors should be narrower in the left-right (±x) direction, such as a square or oval shape. Thus, the shape of the capacitive coupling conductor 114 can be adapted to the purpose.

The first to third exemplary embodiments have been described above, however, various variations are allowed as long as not violating the intent of the present invention.

### REFERENCE SIGNS LIST

1, 2 . . . microstrip antenna, 100, 100′, and 100″, 200 . . . transmission device, 110, 210 . . . transmission substrate, 111, 211 . . . dielectric substrate, 112, 212 . . . feeding line, 113, 213 . . . ground conductor, 114, 114′, 114″. . . capacitive coupling conductor, 120, 220 . . . connector, 121 . . . insulator, 122 . . . inner conductor, 123 . . . outer conductor, 123a . . . mounting portion, 123a1 . . . bottom surface, 123b . . . connecting portion, 300 . . . radiating element, α . . . opening, β . . . gap, εr . . . relative permittivity, λ . . . wavelength in free space, λg . . . effective wavelength

1. A transmission device comprising:
a transmission substrate for transmitting a signal, the transmission substrate including a feeding line and a capacitive coupling conductor that are provided on one side of a plate-shaped dielectric substrate and a ground conductor that is provided on other side of the dielectric substrate; and
a connector for inputting and outputting a signal, the connector including an inner conductor and an outer conductor that is provided outside of the inner conductor, wherein
the connector is provided on the one side of the dielectric substrate on which the feeding line and the capacitive coupling conductor of the transmission substrate are provided, and the inner conductor of the connector is connected to the feeding line, the outer conductor is connected to the capacitive coupling conductor, and the ground conductor of the transmission substrate is not connected to the outer conductor of the connector.

2. The transmission device according to claim 1, wherein, in the transmission substrate, the capacitive coupling conductor and the ground conductor face each other via the dielectric substrate.

3. The transmission device according to claim 2, wherein the ground conductor of the transmission substrate and the outer conductor of the connector are capacitively coupled.

4. The transmission device according to claim 1, wherein, in the capacitive coupling conductor, an opening is formed at a center portion and a gap is formed from an outer edge to the opening, and an end of the feeding line is located at the gap.

5. The transmission device according to claim 1, wherein a shape surrounding the outer edge of the capacitive coupling conductor is any one of polygonal, circular and oval.

6. The transmission device according to claim 1, wherein a dimension from a center of the connector to an outer edge of the capacitive coupling conductor is more than ¼ and less than ½ of an effective wavelength in the dielectric substrate.

7. The transmission device according to claim 1, wherein, among a dimension from a center of the connector to an outer edge of the capacitive coupling conductor, the transmission device transmits a signal with a lower limit of a frequency at which a minimum dimension corresponds to ¼ of an effective wavelength and with an upper limit of a frequency at which a maximum dimension corresponds to ½ of the effective wavelength.

8. An antenna comprising:
a radiating element transmitting and receiving radio waves; and
a transmission device according to claim 1 which the radiating element is connected to and transmits a signal based on the radio waves transmitted and received by the radiating element.

9. The antenna according to claim 8, wherein, among a dimension from a center of the connector to an outer edge of the capacitive coupling conductor, the radiating element transmits and receives radio waves with a lower limit of a frequency at which a minimum dimension corresponds to ¼ of an effective wavelength and with an upper limit of a frequency at which a maximum dimension corresponds to ½ of the effective wavelength.
